(19) United States
(12) Patent Application Publication
(10) Pub. No.: US 2025/0236154 A1
(43) Pub. Date: Jul. 24, 2025

(54) VEHICLE AIR DUCT WITH FIBER-FILM LAMINATE

(71) Applicant: Atieva, Inc., Newark, CA (US)

(72) Inventors: Ahmad Samer Abdel Majid, San Jose, CA (US); Anthony Ressencourt, Fremont, CA (US); Matej Hartman, Ujerd, Hradec Kralove (CZ)

(21) Appl. No.: 18/698,202

(22) PCT Filed: Oct. 5, 2022
(86) PCT No.: PCT/US2022/077582

§ 371 Date: Apr. 3, 2024

Related U.S. Application Data
(60) Provisional application No. 63/262,233, filed on Oct. 7, 2021.

(51) Int. Cl. B60H 1/00; B29D 23/00; B29K 23/00; B29K 67/00; B32B 27/12; B32B 27/32; B32B 27/36

(52) U.S. Cl. CPC B60H 1/00564; B29D 23/00; B32B 27/12; B32B 27/32; B32B 27/36; B29K 2023/12; B29K 2067/003; B32B 2597/00

(57) ABSTRACT

A vehicle air duct comprises: a first end to couple the vehicle air duct to a vehicle heating, ventilation and air conditioning (HVAC) unit; a second end to couple the vehicle air duct to a vehicle air vent; and an air duct of a fiber-film laminate, the air duct coupling the first and second ends to each other, the air duct formed by shells joined to each other, the fiber-film laminate comprising a porous fiber sheet of polymer material, the fiber sheet laminated with a polymer film, wherein the polymer film is at an outward surface of the air duct.

### CROSS-REFERENCE TO RELATED APPLICATION

This application claims priority to U.S. Provisional Patent Application No. 63/262,233, filed on Oct. 7, 2021, and entitled “VEHICLE AIR DUCT WITH FIBER-FILM LAMINATE,” the disclosure of which is incorporated by reference herein in its entirety.

### TECHNICAL FIELD

This document relates to a vehicle air duct with a fiber-film laminate.

### BACKGROUND

Many vehicles manufactured today includes a system designed to provide a flow of air into a cabin such as a passenger compartment. The system can include a heating, ventilation and air conditioning (HVAC) unit coupled to a thermal system in the vehicle. For example, this can allow the HVAC unit to deliver warm or cold air into the cabin according to the settings of one or more controls.

Most such existing systems primarily rely on blow-molded plastic ducts as the conduits of conditioned air from the HVAC unit into the cabin, or vice versa. The blow-molded ducts are relatively heavy and conducive to transmitting acoustics (e.g., by way of sound echoing within the duct). As such, they tend to increase the vehicle weight and contribute to noise, vibration, and harshness (NVH) issues with the vehicle.

### SUMMARY

In a first aspect, a vehicle air duct comprises: a first end to couple the vehicle air duct to a vehicle heating, ventilation and air conditioning (HVAC) unit; a second end to couple the vehicle air duct to a vehicle air vent; and an air duct of a fiber-film laminate, the air duct coupling the first and second ends to each other, the air duct formed by shells joined to each other, the fiber-film laminate comprising a porous fiber sheet of polymer material, the fiber sheet laminated with a polymer film, wherein the polymer film is at an outward surface of the air duct.

Implementations can include any or all of the following features. Each of the shells includes a flange, and where the shells are welded to each other using the flanges. The vehicle air duct further comprises a tab extending from the outward surface of one of the shells, the tab configured for attaching the vehicle air duct. The vehicle air duct further comprises a weakening in the tab, the weakening formed in a compression molding process where the shells are manufactured, the weakening facilitating reorientation of the tab for attaching the vehicle air duct. The tab includes a slit that facilitates attachment of the vehicle air duct. The polymer material includes polyester. The polymer material includes polyethylene succinate. The polymer material includes polyethylene terephthalate (PET). The polymer material includes PET and polypropylene. The polymer material includes PET and high-density polyethylene. The polymer film includes polyurethane. The polymer film includes polyethylene.

In a second aspect, a method of manufacturing a vehicle air duct comprises: forming a fiber-film laminate by layering a porous fiber sheet of polymer material and a polymer film with each other; compression molding the fiber-film laminate into shells for a vehicle air duct; and forming the vehicle air duct by joining the shells to each other, wherein the polymer film is at an outward surface of the vehicle air duct.

Implementations can include any or all of the following features. The shells are formed from a single fiber-film laminate. The fiber-film laminate also forms another vehicle product in the compression molding. The polymer film is at an outward facing surface of the other vehicle product. The other vehicle product is a bracket cover for airbag protection. The bracket cover further comprises a first tab having an opening, and a second tab having a neck-and-hook feature. The method further comprises performing cutting after the compression molding. The cutting forms a tab configured for attaching the vehicle air duct. The method further comprises forming a weakening in the tab in the compression molding, the weakening facilitating reorientation of the tab for attaching the vehicle air duct. The method further comprises forming a slit in the tab that facilitates attachment of the vehicle air duct.

### BRIEF DESCRIPTION OF DRAWINGS

FIG. 1A shows an example of a vehicle air duct.

FIG. 1B schematically shows an example of an HVAC unit, an air duct, and an air vent of a vehicle.

FIGS. 2A-2C show examples of a fiber-film laminate, a deformed fiber-film laminate, and shells that can be used for the vehicle air duct of FIG. 1A.

FIG. 3 shows an example flowchart of a method of manufacturing a vehicle air duct.

FIGS. 4A-4B show an example of another vehicle product that can be formed when compression molding the fiber-film laminate and/or the shells of FIGS. 2A-2C.

FIG. 5 shows an example of using a bracket cover for airbag protection.

FIG. 6 shows an example of a tab that can be used for attaching the vehicle air duct of FIG. 1A.

FIG. 7 shows another example of a tab that can be used for attaching the vehicle air duct of FIG. 1A.

FIG. 8 shows an example of an air duct having a living hinge.

Like reference symbols in the various drawings indicate like elements.

### DETAILED DESCRIPTION

This document describes examples of systems and techniques for air ducts in vehicles. Substantially all air ducts in the vehicle can be made of a fiber-film laminate. In some implementations, the fiber-film laminate can include a porous fiber sheet and a polymer film laminated with each other. For example, the porous fiber sheet can include a polyester fiber material and the polymer film can include polyurethane. Using a fiber-film laminate can provide air ducts that weigh significantly less than other approaches, such as those made from blow-molded plastic. The polymer film can be positioned on an outward surface of the air duct and can prevent or reduce loss of air during operation. The pores of the porous fiber sheet can reduce the acoustic transmission properties of the air duct compared to other approaches (e.g., by reducing echoing within the duct). As such, a vehicle air duct that includes a porous fiber sheet can improve an NVH level of the vehicle. In some implementations, a vehicle air duct as described herein can be relatively more conducive to be temporarily deformed by squeezing (e.g., by hand or using a tool) than other approaches, making the air duct easier to fit into a narrow space during installation. In some implementations, the air duct (or multiple air ducts) can be installed onto an instrument panel ahead of time, before the instrument panel is installed into the cabin of the vehicle. In such a scenario, a vehicle air duct as described herein can be relatively more conducive to being temporarily folded or bent out of shape (e.g., by hand or using a tool) than other approaches, thereby simplifying the installation of the instrument panel.

Examples described herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. A vehicle can be powered exclusively by electricity, or can use one or more other energy sources in addition to electricity, to name just a few examples.

Examples described herein refer to a porous fiber sheet. As used herein, a porous fiber sheet includes multiple fibers of a polymer material arranged so that the sheet has a random or ordered pattern of pores. The porous fiber sheet can have any of multiple porosities within a range from almost zero porosity to about 60% porosity. The porous fiber sheet can have a density within a range of fiber densities from about 300 to about 1300 grams per square meter. The porous fiber sheet can include (e.g., be substantially made from) a polymer material. The polymer material can be a thermoplastic material or a thermosetting material, to name just two examples. In some implementations, the porous fiber sheet can include polyester. For example, polyester fibers can be included. In some implementations, the porous fiber sheet can include polyethylene succinate (PES). In some implementations, the porous fiber sheet can include polyethylene terephthalate (PET). For example, the polymer material can include PET and polypropylene (PP). As another example, the polymer material can include PET and high-density polyethylene (HDPE).

Examples described herein refer to materials (e.g., shells of a vehicle air duct) being joined to each other. As used herein, joining of an air duct includes any technique that will create a bond of sufficient strength to avoid excessive air loss and prevent separation of the joint during use. In some implementations, welding can be performed. Generally, welding can involve applying heat and pressure to a stack of at least two layers to create a bond. In some implementations, laser welding can be used.

Examples herein may refer to a front, rear, top, or a bottom. These and similar expressions identify things or aspects in a relative way based on an express or arbitrary notion of perspective. That is, these terms are illustrative only, used for purposes of explanation, and do not necessarily indicate the only possible position, direction, and so on.

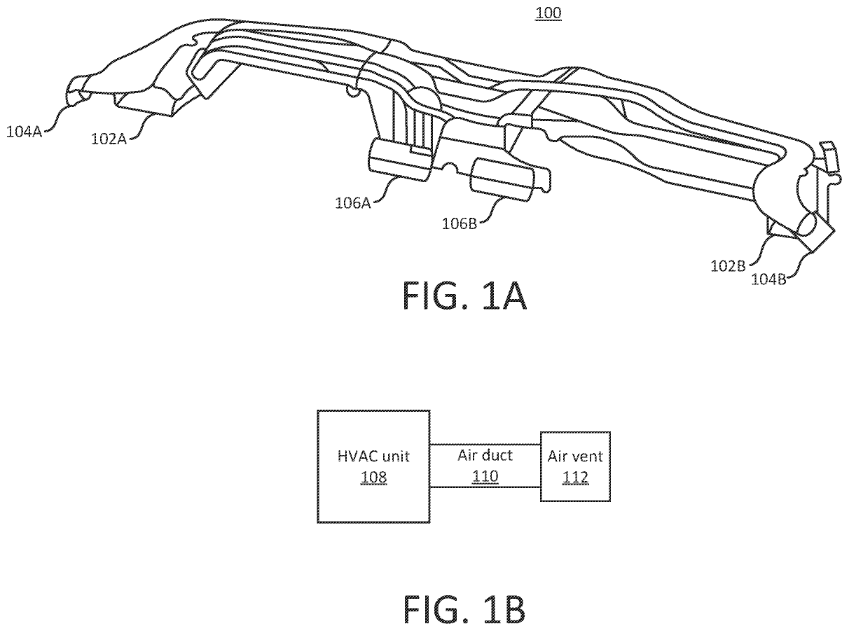

FIG. 1A shows an example of a vehicle air duct 100. The vehicle air duct 100 can be used with, and/or be manufactured using, one or more other examples described elsewhere herein. The vehicle air duct 100 can be configured for installation at a vehicle instrument panel (e.g., a dashboard) to facilitate the flow of air to the cabin. To that end, the vehicle instrument panel can include one or more air vents for introducing air, and one or more air returns where air can be circulated back to the HVAC unit. The vehicle air duct 100, moreover, can include one or more ends that are configured for coupling the vehicle air duct 100 to the air vent(s) of the vehicle, and/or one or more ends for coupling the vehicle air duct 100 to the air return(s) of the vehicle. Here, the vehicle air duct 100 includes ends 102A-102B. For example, the end 102A can be used for coupling the vehicle air duct 100 to a left air vent at the left end of the instrument panel, and the end 102B can be used for coupling the vehicle air duct 100 to a right air vent at the right end of the instrument panel. Here, the vehicle air duct 100 also includes ends 104A-104B. For example, the end 104A can be used for coupling the vehicle air duct 100 to a left-side air vent at a left side door, and the end 104B can be used for coupling the vehicle air duct 100 to a right-side air vent at a right side door. Here, the vehicle air duct 100 also includes ends 106A-106B. For example, the end 106A can be used for coupling the vehicle air duct 100 to a left central air vent at a center of the instrument panel, and the end 106B can be used for coupling the vehicle air duct 100 to a right central air vent at the center of the instrument panel. Other approaches can be used. The vehicle air duct 100 has one or more ends for coupling to an HVAC unit, which is/are not visible in the present view.

The vehicle air duct 100 can be made by joining two or more shells to each other. Such shells can have a variety of shapes and/or sizes. In some implementations, two half-shells can be joined to form the vehicle air duct 100. In some implementations, shells of different proportions (e.g., not half and half) can be joined to each other. Each shell includes a fiber-film laminate that comprises a porous fiber sheet of polymer material, and a polymer film. The polymer film is at an outward surface of the vehicle air duct 100. For example, the porous fiber sheet can be at an inside surface of the vehicle air duct 100 and form the channel for air flow.

FIG. 1B schematically shows an example of an HVAC unit 108, an air duct 110, and an air vent 112 of a vehicle. The HVAC unit 108, the air duct 110, and/or the air vent 112, can be used with one or more other examples described elsewhere herein. The example illustrates that the air duct 110 can serve as a conduit of air flow from the HVAC unit 108 to one or more instances of the air vent 112. For example, the air duct 110 can have a first end that couples the air duct 110 to the HVAC unit 108. As another example, the air duct 110 can have a second end that couples the air duct 110 to the air vent 112.

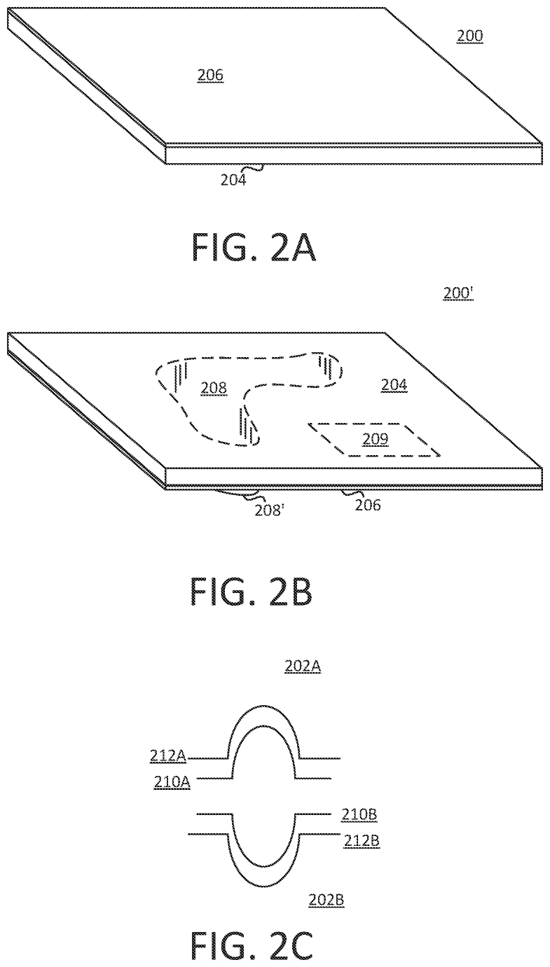

FIGS. 2A-2C show examples of a fiber-film laminate 200, a deformed fiber-film laminate 200′, and shells 202A-202B that can be used for the vehicle air duct 100 of FIG. 1A. The fiber-film laminate 200, or the deformed fiber-film laminate 200′, and/or the shells 202A-202B can be used with one or more other examples described elsewhere herein. FIG. 2A shows that a porous fiber sheet 204 can be used. The porous fiber sheet 204 includes a polymer material. For example, the porous fiber sheet 204 can include one or more of polyester; PES; PET; PET and PP; PET and HDPE; and combinations thereof.

A polymer film 206 can be used. In some implementations, the polymer film 206 is layered with the porous fiber sheet 204. For example, substantially same-size pieces of the porous fiber sheet 204 and the polymer film 206 can be obtained from stock of the respective materials and be assembled (e.g., stacked) into a two-sheet assembly. In some implementations, the polymer film 206 includes polyurethane. In some implementations, the polymer film 206 includes polyethylene. The polymer film 206 can have any of multiple thicknesses in a range that allows the polymer film 206 to conform to the curvature of the porous fiber sheet 204 during a compression molding process without rupture of the polymer film 206. Solely as an example of only a single one of such possible ranges, the polymer film 206 can have a thickness that is in the range of about 0.05 millimeters (mm) to about 0.5 mm. The present orientation, with the porous fiber sheet 204 and the polymer film 206 oriented horizontally, with one on top of the other, is shown for illustrative purposes only.

The fiber-film laminate 200 can be subjected to compression molding to form one or more shells for a vehicle air duct. Any of multiple forms of compression molding can be used. In some implementations, a heated mold has two parts that form a mold cavity. Heat and pressure are applied to deform at least part of the molding material.

FIG. 2B shows that the deformed fiber-film laminate 200′ is oriented upside down compared to the fiber-film laminate 200 in FIG. 2A. For example, this can occur when the fiber-film laminate 200 is turned over so that the polymer film 206 faces a mold cavity that is in a lower half of a mold. As heat and pressure are applied in the compression molding process, the fiber-film laminate 200 (FIG. 2A) is deformed so as to become the deformed fiber-film laminate 200′. One or more deformations can be present in the deformed fiber-film laminate 200′. Here, a cavity 208 is formed in the deformed fiber-film laminate 200′ by deformation in the downward direction as illustrated. The cavity 208 can have any shape. For example, the cavity 208 can be shaped so as to form one shell of an air duct. In some implementations, the deformation can extend to one or more edges of the deformed fiber-film laminate 200′. For example, the cavity 208 can extend to at least one edge of the deformed fiber-film laminate 200′ so as to form an opening in the shell. The polymer film 206 is at an outward surface of the cavity 208. For example, a convex portion 208′ of the cavity 208, here partially visible at the bottom of the deformed fiber-film laminate 200′, is covered by a portion of the polymer film 206.

Another product 209 can also be formed by the deformed fiber-film laminate 200′. The other product 209 can have any shape and is here schematically shown for illustrative purposes. In some implementations, the other product 209 is another shell for the air duct. For example, the other shell can be complementary to the shell to be formed from the material defining the cavity 208. In some implementations, the other product 209 can be a different vehicle product, such as, but not limited to, the examples to be provided below.

FIG. 2C schematically shows the shells 202A-202B in a side view. One or more of the shells 202A-202B can be formed by the deformed fiber-film laminate 200′ (FIG. 2B). For example, both of the shells 202A-202B are formed by one instance of the deformed fiber-film laminate 200′. As another example, one of the shells 202A-202B is formed by one instance of the deformed fiber-film laminate 200′, and another one of the shells 202A-202B is formed by another instance of the deformed fiber-film laminate 200′. Each of the shells 202A-202B can include at least one flange, and the shells 202A-202B can be joined to each other using the flange.

Here, the shell 202A includes a porous fiber sheet 210A and a polymer film 212A. The polymer film 212A is at an outward surface of the shell 202A compared to the porous fiber sheet 210A, which may be at an inside surface of the shell 202A. Correspondingly, the shell 202B includes a porous fiber sheet 210B and a polymer film 212B. The polymer film 212B is at an outward surface of the shell 202B compared to the porous fiber sheet 210B, which may be at an inside surface of the shell 202B. The shells 202A-202B can be joined together (e.g., in the orientation shown) to form a vehicle air duct. The shells 202A-202B are here exemplified as separate from each other, and having separated layers, for illustrative purposes. Each of the porous fiber sheets 210A-210B and the polymer films 212A-212B is here illustrated as a line for simplicity.

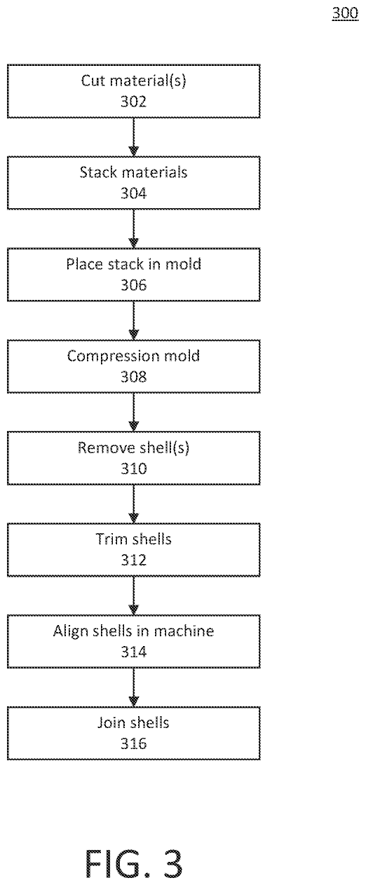

FIG. 3 shows an example flowchart of a method 300 of manufacturing a vehicle air duct. The method 300 can be used with one or more other examples described elsewhere herein. Two or more of the operations of the method 300 can be performed in a different order unless otherwise indicated. More or fewer operations can be performed.

At operation 302, one or more sheets of material can be cut to size from a supply of stock material. For example, the porous fiber sheet 204 and/or the polymer film 206 (FIG. 2A) can be cut into appropriate size(s) considering the vehicle air duct that is to be manufactured.

At operation 304, the materials can be stacked. For example, the porous fiber sheet 204 and the polymer film 206 can be stacked as shown in FIG. 2A or in FIG. 2B.

At operation 306, the stack can be placed in a mold for compression molding. For example, at least one of the mold halves is shaped so as to define a mold cavity, and the stack is placed against (e.g., on top of) that mold cavity with the polymer film 206 facing the mold cavity.

At operation 308, compression molding can be performed. In some implementations, heat and pressure are applied according to a predefined schedule taking into account the materials and/or thicknesses of the porous fiber sheet 204 and the polymer film 206. For example, the compression molding can be applied to the fiber-film laminate 200 (FIG. 2A) to form the deformed fiber-film laminate 200′ (FIG. 2B).

At operation 310, one or more shells, formed by the deformed fiber-film laminate, can be removed from the mold.

At operation 312, the shell(s) can be trimmed. For example, the deformed fiber-film laminate 200′ (FIG. 2B) can be trimmed to form either or both of the shells 202A-202B (FIG. 2C).

At operation 314, the shells can be aligned in a machine for joining into the air duct. Two or more shells can be formed into the air duct. The shells can be placed into alignment where one or more of their respective edges meets a corresponding edge of another shell. For example, the alignment can be done using one or more pins that control the locations of the shells.

At operation 316, the shells can be joined. In some implementations, heat and pressure can be applied at the joint to form a seam between the shells (e.g., by welding). For example, extra material can be removed. This can complete the formation of the air duct.

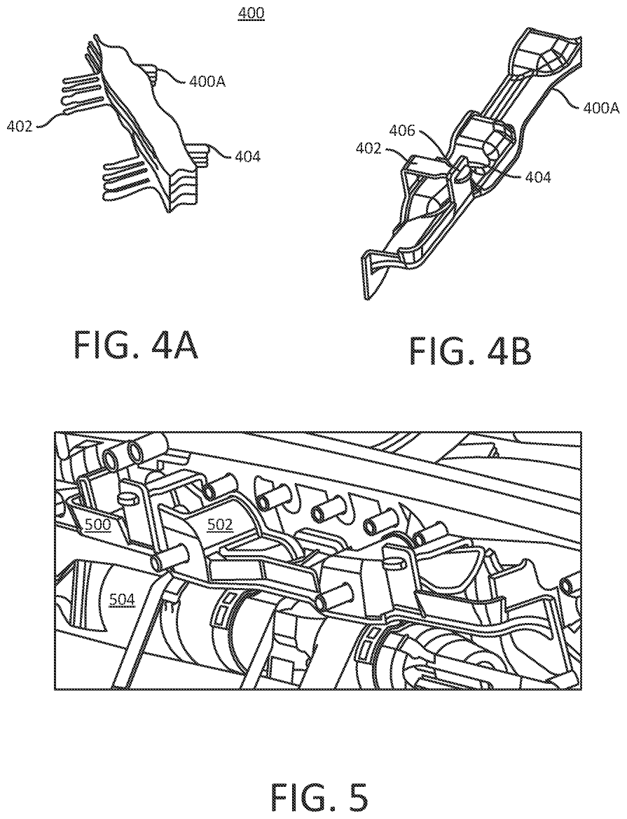

FIGS. 4A-4B show an example of another vehicle product 400 that can be formed when compression molding the fiber-film laminate 200 (FIG. 2A). The other vehicle product 400 can be used with one or more other examples described elsewhere herein. Here, the vehicle product 400 is a stack of individual products 400A that are substantially identical to each other. Each of the individual products 400A can be a product for the same vehicle as the air duct that was made from the fiber-film laminate, or for another vehicle. The individual product 400A is also made of the fiber-film laminate. For example, one side of the individual product 400A can be covered by the polymer film. In some implementations, each of the individual products 400A can be referred to as a cover for a bracket. For example, this can be the bracket for a grab handle inside the cabin of a vehicle (e.g., mounted at a cantrail or on one of the pillars).

The design of the individual product 400A can facilitate an advantageous attachment strategy. For example, cost and weight can be reduced (e.g., because clips or other fasteners are not used). The individual product 400A can be molded substantially flat (e.g., as in FIG. 4A). The individual product 400A can include tabs 402 and 404. The tabs 402 and 404 can extend essentially in opposite directions from the body of the individual product 400A. At least one of the tabs 402 and 404 can have an opening and the other tab can have a shape feature. FIG. 4B shows that the tab 404 can have an opening 406 and the tab 402 can have a neck-and-hook feature. The individual product 400A can be wrapped onto another product (e.g., a grab handle bracket). Attachment can be done by slipping and twisting in the neck and hook feature of the tab 402 into the opening 406. As such, the tabs 402 and 404 can facilitate self-attachment by the individual product 400A to any of a variety of structures without separate clips or other fasteners.

The tabs 402 and 404 can be used with other examples described herein. In some implementations, any of the air ducts shown and/or described herein can have tabs based on the tabs 402 and 404. This can allow the air duct(s) to self-attach in various ways.

FIG. 5 shows an example of using a bracket cover 500 for airbag protection. The bracket cover 500 can be used with one or more other examples described elsewhere herein. The bracket cover 500 can be one of the individual products 400A (FIGS. 4A-4B). The bracket cover 500 can be used in a vehicle to cover a bracket 502. For example, the bracket 502 is made from a relatively hard material such as metal, and may have sharp edges. An airbag 504 (here partially shown) may be mounted near the bracket 502. In some implementations, the airbag 504 is a curtain airbag that is mounted at a part of the vehicle body that extends along one or more side windows. For example, deploying the airbag 504 can form an inflated curtain that extends along at least part of a window opening to protect the occupant against impact by the vehicle frame (or by another vehicle) in a collision. The bracket cover 500 can be positioned between the bracket 502 and the airbag 504 so that upon airbag deployment, the bracket cover 500 reduces or eliminates occurrences of the bladder of the airbag 504 contacting the bracket 502. In some implementations, the polymer-film side of the bracket cover 500 can face the airbag 504. For example, the polymer film can provide a relatively low-friction surface that can be advantageous for receiving the impact of the deploying airbag bladder.

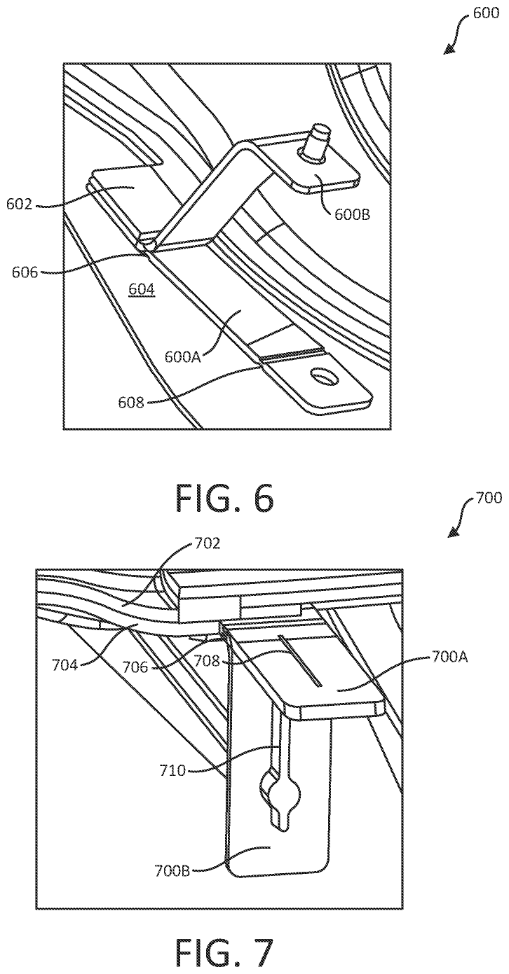

FIG. 6 shows an example of a tab 600 that can be used for attaching the vehicle air duct 100 of FIG. 1A. The tab 600 can be used with one or more other examples described elsewhere herein. The tab 600 can facilitate attachment of the vehicle air duct to another component of the vehicle, including, but not limited to, a vehicle cross-car beam, another portion of the vehicle body, and/or to the instrument panel.

The tab 600 is shown in two positions indicated by a tab 600A and a tab 600B, respectively. The tab 600A corresponds to the tab 600 at the time of manufacture of the air duct. In some implementations, the air duct includes shells 602 and 604 that are joined to each other. The tab 600A can be formed as integral with the shell 604 at the time of compression molding. The tab 600A can have one main surface that is covered with polymer film (e.g., the surface facing in the direction away from the other shell, the shell 602). For example, the opposite main surface of the tab 600A (e.g., the surface facing in the direction toward the shell 602) can be covered with the porous fiber sheet.

The tab 600B corresponds to the tab 600 when the air duct has been installed. The tab 600A can have one or more weakenings that facilitate deformation and/or reorientation of the tab 600A. Here, weakenings 606 and 608 are shown. For example, the tab 600B as arranged can be characterized as a living hinge in that it provides a flexible and reliable attachment. Other approaches can be used.

FIG. 7 shows another example of a tab 700 that can be used for attaching the vehicle air duct of FIG. 1A. The tab 700 can be used with one or more other examples described elsewhere herein. The tab 700 can facilitate attachment of the vehicle air duct to another component of the vehicle, including, but not limited to, a vehicle cross-car beam, another portion of the vehicle body, and/or to the instrument panel.

The tab 700 is shown in two positions indicated by a tab 700A and a tab 700B, respectively. The tab 700A corresponds to the tab 700 at the time of manufacture of the air duct. In some implementations, the air duct includes shells 702 and 704 that are joined to each other. The tab 700A can be formed as integral with the shell 704 at the time of compression molding. The tab 700A can have one main surface that is covered with polymer film (e.g., the surface facing in the direction away from the other shell, the shell 702. For example, the opposite main surface of the tab 700A (e.g., the surface facing in the direction toward the shell 702) can be covered with the porous fiber sheet.

The tab 700B corresponds to the tab 700 when the air duct has been installed. The tab 700A can have one or more weakenings that facilitate deformation and/or reorientation of the tab 700A. Here, a weakening 706 is shown. For example, the tab 700B as arranged can be characterized as a living hinge in that it provides a flexible and reliable attachment. Other approaches can be used.

The tab 700A can include one or more slits. In some implementations, a slit 708 can be formed. The slit 708 can facilitate attachment to one or more other structures. Here, a beam 710 is part of the structure of the vehicle (including, but not limited to, as a part of a cross-car beam assembly). The tab 700A can be coupled to the beam 710 using the slit 708, to form the tab 700B. For example, an interference fit, or friction fit, between the beam 710 and the slit 708 can provide a flexible and reliable attachment.

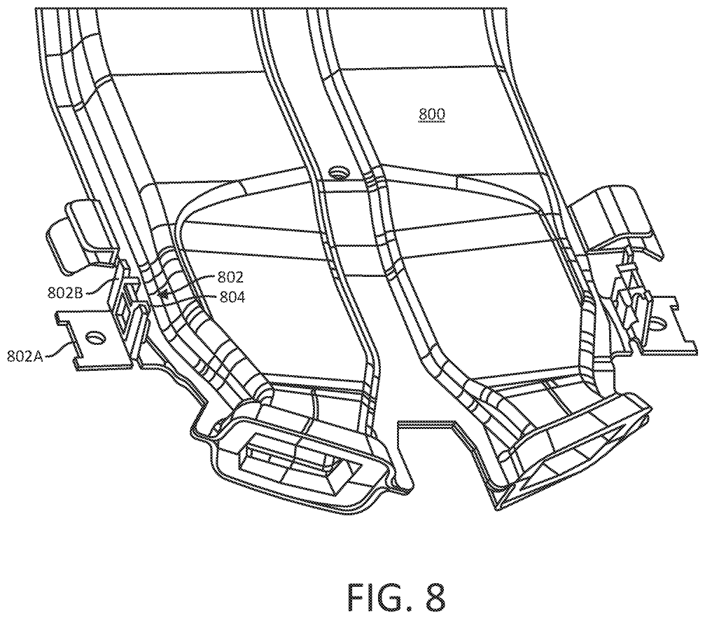

FIG. 8 shows an example of an air duct 800 having a living hinge 802. The air duct 800 and/or the living hinge 802 can be used with one or more other examples described elsewhere herein. In some implementations, the air duct 800 can be characterized as a center console duct for a vehicle. The living hinge 802 can facilitate attachment of the air duct 800 to another component of a vehicle, including, but not limited to, a vehicle cross-car beam, another portion of the vehicle body, and/or to the instrument panel.

The living hinge 802 is shown in two positions indicated by a tab 802A and a tab 802B, respectively. The tab 802A corresponds to the living hinge 802 at the time of manufacture of the air duct 800. In some implementations, the air duct 800 includes shells that are joined to each other. The tab 802A can be formed as integral with one of the shells (e.g., the lower shell in this view) at the time of compression molding. The tab 802B corresponds to the living hinge 802 when the air duct 800 has been installed. The tab 802A can have one or more weakenings that facilitate deformation and/or reorientation of the tab 802A. Here, the tab 802B is provided with a clip 804 that can serve to secure the air duct 800 to another structure by way of the tab 802B.

The tab 802A and/or other tabs of the air duct 800 can be designed and tuned in a mold in such a way that allows it/them to be thin enough to make clip installation easy for an operator, yet makes the tab strong enough for handling and attaching into the console without breaking and surviving in application during a vehicle lifetime.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to =0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A vehicle air duct comprising:
a first end to couple the vehicle air duct to a vehicle heating, ventilation and air conditioning (HVAC) unit;
a second end to couple the vehicle air duct to a vehicle air vent; and
an air duct of a fiber-film laminate, the air duct coupling the first and second ends to each other, the air duct formed by shells joined to each other, the fiber-film laminate comprising a porous fiber sheet of polymer material, the fiber sheet laminated with a polymer film, wherein the polymer film is at an outward surface of the air duct.

2. The vehicle air duct of claim 1, wherein each of the shells includes a flange, and where the shells are welded to each other using the flanges.

3. The vehicle air duct of claim 1, further comprising a tab extending from the outward surface of one of the shells, the tab configured for attaching the vehicle air duct.

4. The vehicle air duct of claim 3, further comprising a weakening in the tab, the weakening formed in a compression molding process where the shells are manufactured, the weakening facilitating reorientation of the tab for attaching the vehicle air duct.

5. The vehicle air duct of claim 3, wherein the tab includes a slit that facilitates attachment of the vehicle air duct.

6. The vehicle air duct of claim 1, wherein the polymer material includes polyester.

7. The vehicle air duct of claim 6, wherein the polymer material includes polyethylene succinate.

8. The vehicle air duct of claim 6, wherein the polymer material includes polyethylene terephthalate (PET).

9. The vehicle air duct of claim 8, wherein the polymer material includes PET and polypropylene.

10. The vehicle air duct of claim 8, wherein the polymer material includes PET and high-density polyethylene.

11. The vehicle air duct of claim 1, wherein the polymer film includes polyurethane.

12. The vehicle air duct of claim 1, wherein the polymer film includes polyethylene.

13. A method of manufacturing a vehicle air duct, the method comprising:
forming a fiber-film laminate by layering a porous fiber sheet of polymer material and a polymer film with each other;
compression molding the fiber-film laminate into shells for a vehicle air duct; and
forming the vehicle air duct by joining the shells to each other, wherein the polymer film is at an outward surface of the vehicle air duct.

14. The method of claim 13, wherein the shells are formed from a single fiber-film laminate.

15. The method of claim 13, wherein the fiber-film laminate also forms another vehicle product in the compression molding.

16. The method of claim 15, wherein the polymer film is at an outward facing surface of the other vehicle product.

17. The method of claim 16, wherein the other vehicle product is a bracket cover for airbag protection.

18. The method of claim 17, wherein the bracket cover further comprises a first tab having an opening, and a second tab having a neck-and-hook feature.

19. The method of claim 13, further comprising performing cutting after the compression molding.

20. The method of claim 19, wherein the cutting forms a tab configured for attaching the vehicle air duct.

21. The method of claim 20, further comprising forming a weakening in the tab in the compression molding, the weakening facilitating reorientation of the tab for attaching the vehicle air duct.

22. The method of claim 20, further comprising forming a slit in the tab that facilitates attachment of the vehicle air duct.
